(19) United States
(12) Patent Application Publication
(10) Pub. No.: US 2006/0000335 A1
(43) Pub. Date: Jan. 5, 2006

(54) Rolled paper dispenser with sensor

(76) Inventor: Cheng-Chang Chen, Hsin-Chuang City (TW)

Correspondence Address: LADAS & PARRY LLP, 224 SOUTH MICHIGAN AVENUE, SUITE 1600, CHICAGO, IL, 60604, US

(21) Appl. No.: 10/977,002

(22) Filed: Oct. 29, 2004

(30) Foreign Application Priority Data
Jun. 30, 2004 (TW) 093119243

(51) Int. Cl. B26D 1/36

(52) U.S. Cl. 83/649; 83/949; 83/331

(57) ABSTRACT

A rolled paper dispenser includes a main housing having a dispensing hole, a first roller mounted removably within the main housing and adapted to support a roll of paper, a paper feeding unit including a pair of contacting second rollers mounted rotatably within the main housing for advancing the paper from the roll of paper, a drive unit connected to the paper feeding unit, a paper cutter disposed within the main housing adjacent to the dispensing hole, and a sensor unit connected electrically to the drive unit to activate the second rollers through the drive unit so as to control advancement of a section of the paper to the dispensing hole.

### CROSS-REFERENCE TO RELATED APPLICATION

This application claims priority of Taiwanese Application No. 093119243, filed on Jun. 30, 2004.

### BACKGROUND OF THE INVENTION

1. Field of the Invention

The invention relates to a dispenser, more particularly to a rolled paper dispenser with a sensor.

2. Description of the Related Art

Referring to FIGS. 1 and 2, a conventional tissue dispenser 1 includes a housing 11, a paper cutter 12, a large feed roller 13, and a small feed roller 14 in contact with the large feed roller 13.

The housing 11 defines a receiving chamber 15, and includes left and right sidewalls 111, 112, each of which has a support seat 16 projecting from an inner face thereof. The support seats 16 of the left and right sidewalls 111, 112 are aligned so as to support a roll of paper 2. A dispensing hole 17 is formed on a bottom portion of a front wall 113 of the housing 11, and extends from the front wall 113 toward the receiving chamber 15. The large and small feed rollers 13, 14 are connected pivotally to the left and right sidewalls 111, 112 above the dispensing hole 17, and are disposed in generally parallel relationship with the support seat 16. A gear 131 is provided between each end of the large feed roller 13 and a corresponding left or right sidewall 111, 112.

The paper cutter 12 is located under the small feed roller 14, and has two opposite ends fixed on the left and right sidewalls 111, 112 of the housing 11. The paper cutter 12 has a main body 121, and a serrated section 122 extending downwardly from the main body 121 toward the dispensing hole 17.

A knob 18 is connected movably to the right sidewall 112 of the housing 11. A curved serrated strip 19 is connected to the knob 18, and meshes with the gear 131 so that the knob 18 can operate the large feed roller 13 to rotate in a single direction through the meshing action of the curved serrated strip 19 and the gear 131.

To prepare the tissue dispenser 1 for use, the left or the right sidewall 111, 112 of the housing 11 is removed so as to enable mounting of the roll of paper 2 on the support seat 16. Paper wound around the roll of paper 2 is then pulled, and is fed between contact surfaces of the large and small feed rollers 13, 14 so that a section of the paper extends through the dispensing hole 17. Next, the knob 18 is pulled downwardly so as to rotate the large feed roller 13, thereby resulting in another section of the paper rolling into the dispensing hole 17. The knob 18 may be continuously operated until a desired length of paper comes out of the dispensing hole 17, after which the free end of the paper is forced sideward so as to be cut by the blade portion 122.

The conventional tissue dispenser 1 makes use of the knob 18 to roll out the paper, and the blade portion 122 to cut the paper. However, when the tissue dispenser 1 is disposed in a public place, the knob 18 is easily contaminated with germs. Furthermore, when the paper is pulled at an unsuitable angle, an irregular cut of the paper may be obtained. If the hands of the user are wet during this operation, which is typically the case, the remaining portion of the paper may become wet due to surface tension, thereby adversely affecting the sanitation of the paper. Moreover, the knob 18 has to be pulled down during each use, thereby rendering the conventional tissue dispenser 1 inconvenient to use.

### SUMMARY OF THE INVENTION

Therefore, the object of the present invention is to provide a rolled paper dispenser that can automatically roll out paper into a dispensing hole.

Another object of the present invention is to provide a rolled paper dispenser that can enhance the sanitation of the paper prior to exiting the dispenser.

According to this invention, a rolled paper dispenser comprises a main housing having a dispensing hole, a first roller mounted removably within the main housing and adapted to support a roll of paper, a paper feeding unit including a pair of contacting second rollers mounted rotatably within the main housing for advancing the paper from the roll of paper, a drive unit disposed within the main housing and connected to the paper feeding unit, a paper cutter disposed within the main housing adjacent to the dispensing hole, and a sensor unit disposed within the main housing and connected electrically to the drive unit to activate the second rollers through the drive unit so as to control advancement of a section of the paper to the dispensing hole.

### BRIEF DESCRIPTION OF THE DRAWINGS

Other features and advantages of the present invention will become apparent in the following detailed description of the preferred embodiment with reference to the accompanying drawings, of which:

FIG. 1 is a perspective view of a conventional tissue dispenser;

FIG. 2 is a sectional side view of FIG. 1;

FIG. 3 is an exploded perspective view of the preferred embodiment of a rolled paper dispenser according to the present invention;

FIG. 4 is a sectional side view of the preferred embodiment in an assembled state;

FIG. 5 is a perspective view to illustrate an alternative form of support arms of the preferred embodiment; and

FIG. 6 is a fragmentary sectional view of a fastening unit of the preferred embodiment.

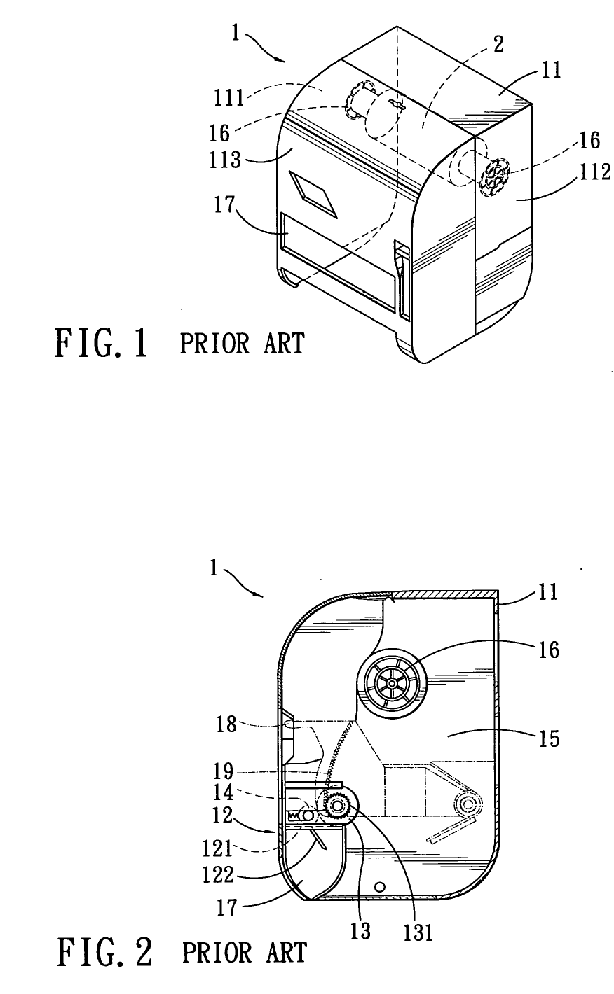

### DETAILED DESCRIPTION OF THE PREFERRED EMBODIMENT

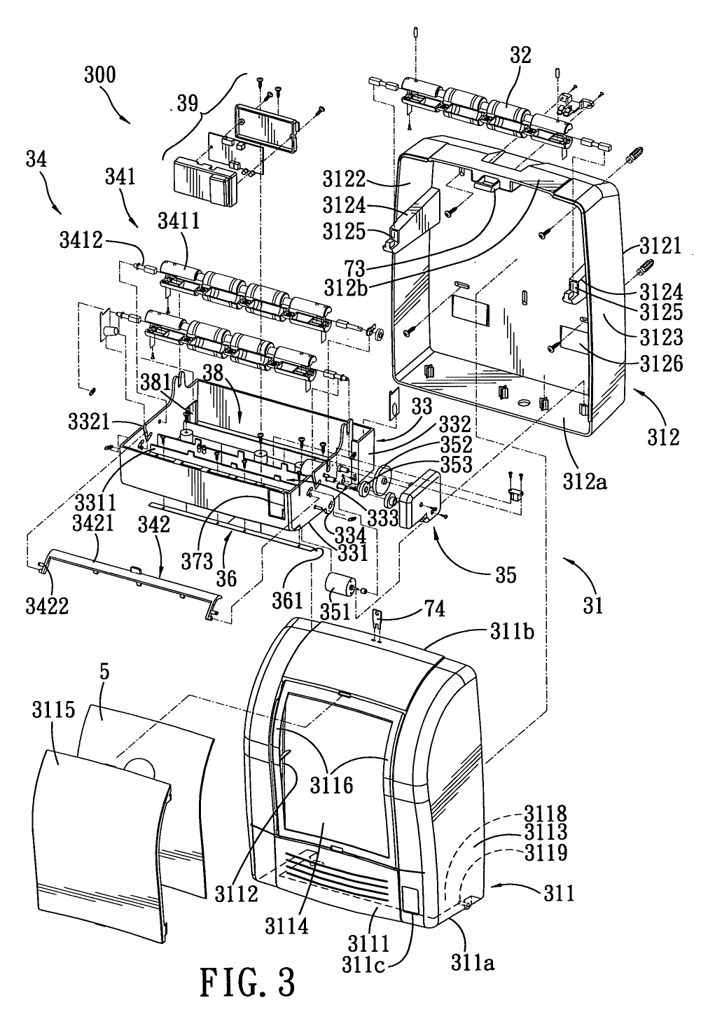

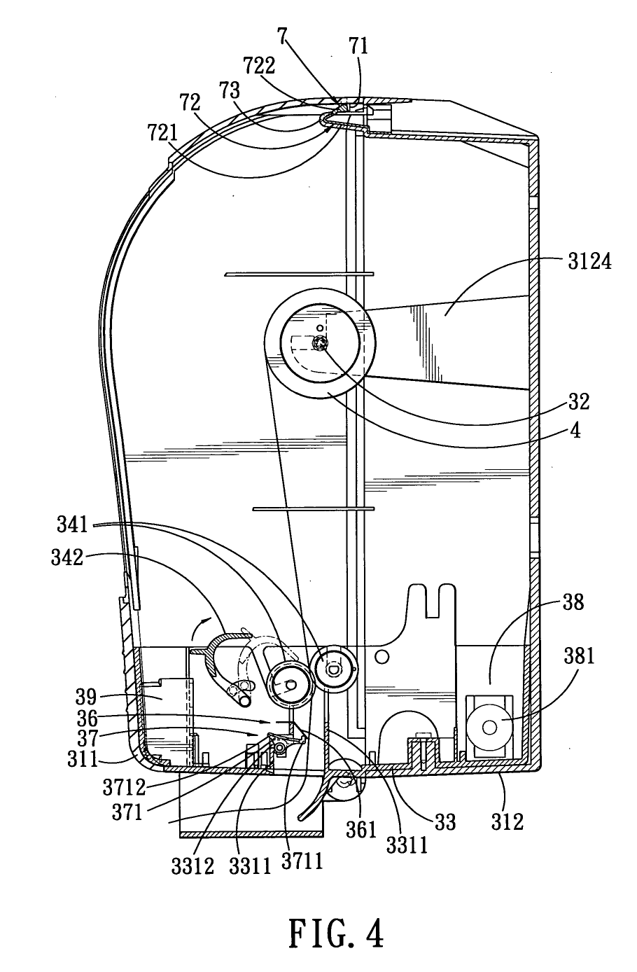

Referring to FIGS. 3 and 4, the preferred embodiment of a rolled paper dispenser 300 according to the present invention is shown to comprise a main housing 31, a first roller 32, a paper feeding unit 34, a drive unit 35, a paper cutter 36, and a sensor unit 37.

The main housing 31 has a dispensing hole 333, and includes a rear casing 312, a base casing 33, and a front casing 311.

The front casing 311 has left and right first sidewalls 3112, 3113, and a front wall 3111 between the first sidewalls 3112, 3113. A central portion of the front wall 3111 is formed with an opening 3114. The opening 3114 is surrounded by lip pieces 3116. A transparent plate 3115 is removably connected to the front wall 3111 to cover the opening 3114. An advertising article 5 may be disposed behind the transparent plate 3115 and clamped between the transparent plate 3115 and the lip pieces 3116 around the opening 3114. The front casing 311 further has a bottom flange 311a projecting from the first sidewalls 3112, 3113 and the front wall 3111 for connection with the base casing 33, and a top end 311b connected detachably to a top end 312b of the rear casing 312. The bottom flange 311a defines a cutout portion 3118.

The rear casing 312 has a bottom end 312a, the top end 312b, left and right second sidewalls 3122, 3123, and a rear wall 3121 between the second sidewalls 3122, 3123. Left and right support arms 3124 project forwardly from the rear wall 3121. One end of each support arm 3124 that is distal from the rear wall 3121 is formed with a groove 3125. The rear wall 3121 is formed with two spaced-apart tongue pieces 3126.

The first roller 32 is mounted removably within the main housing 31, and is adapted to support a roll of paper 4. The first roller 32 is supported by the support arms 3124, and is received removably in the grooves 3125 in the support arms 3124.

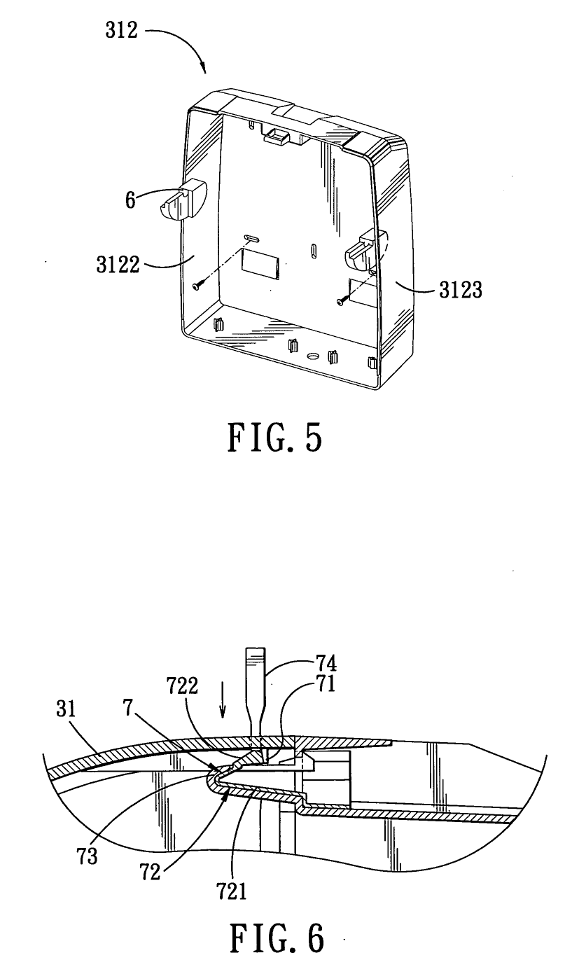

In this embodiment, the opening 3114 and the transparent plate 3115 are provided on the front casing 311 to facilitate clamping of the advertising article 5. Since this structure is not pertinent to the present invention, a detailed description of the same will be dispensed herewith for the sake of brevity. Furthermore, each support arm 3124 in this embodiment may be replaced by a projecting ear 6, which projects from one of the second sidewalls 3122, 3123, as shown in FIG. 5, or any other suitable configuration that can provide the same function as the support arms 3124. Moreover, while the front and rear casings 311, 312 have a rectangular cross-section in this embodiment, they may have any other polygonal shape according to the present invention.

The base casing 33 is inserted partially into and is attached removably to the rear casing 312 adjacent to the bottom end 312a. The bottom flange 311a of the front casing 311 is connected pivotally to the base casing 33. The base casing 33 has a bottom wall 331, and a surrounding wall 332 extending upwardly from a peripheral edge of the bottom wall 331. Two spaced-apart partition walls 3311 extend upwardly from a central portion of the bottom wall 331, and define therebetween the dispensing hole 333. The partition walls 3311 have a height lower than that of the surrounding wall 332. The surrounding wall 332 includes a rear section engaged tightly to the tongue pieces 3126, and two opposite lateral sections having top edges formed respectively with a plurality of grooves 3321.

Two pivoting ears 334 project downwardly and respectively from two opposite ends of the bottom wall 331 of the base casing 33 proximate to the dispensing hole 333, and are connected pivotally to the protrusions 3119 that protrude from the bottom flange 311a of the front casing 311 toward the cutout portion 3118, so that the front casing 311 can rotate relative to the base casing 33.

To engage the front and rear casings 311, 312, a fastening unit 7 is provided. The fastening unit 7 includes a projection 71 that projects downwardly from the top end 311b of the front casing 311, and a resilient hook 72 provided on the top end 312b of the rear casing 312 to engage resiliently the projection 71. The resilient hook 72 is disposed within a receptacle 73, which is connected to the top end 312b of the rear casing 312. The resilient hook 72 has a main section 721 fitted in the receptacle 73, and an engaging section 722 extending upwardly from one end of the main section 721. When the top end 311b of the front casing 311 is pushed against the top end 312b of the rear casing 312, the engaging section 722 engages the projection 71, as best shown in FIGS. 4 and 6.

To disengage the front and rear casings 311, 312, a key 74 is inserted into a hole at the top end 311b of the front casing 311 so as to press downwardly the engaging section 722 so that the engaging section 722 is released from the projection 71, thereby allowing separation between the front and rear casings 311, 312.

In this embodiment, the base casing 33 is first connected to the rear casing 312, after which the front casing 311 is connected to the base casing 33 so that the front casing 311 is pivotable relative to the base casing 33 as described above. However, the construction of the main housing 31 should not be limited only thereto so long as the connection between the front casing 311 and the base casing 33 can facilitate installation and replacement of the roll of paper 4. For example, the front and rear casings 311, 312 may be directly and pivotally connected to each other at their bottom portions, or the front casing 311 may be connected non-pivotally to the rear casing 312.

The paper feeding unit 34 includes a pair of second rollers 341 mounted rotatably on the base casing 33 and located above the dispensing hole 333. Each second roller 341 has a contact surface 3411, and two opposite ends 3412 inserted rotatably into the respective grooves 3321 in the surrounding wall 332 of the base casing 33. The contact surfaces 3411 of the second rollers 341 are in contact with each other such that when one of the second rollers 341 rotates in a first direction, the other one of the second rollers 341 is brought to rotate in a second direction opposite to the first direction. As such, an end of paper wound around the roll of paper 4 can pass between the second rollers 341 and advances into the dispensing hole 333. To enhance the traction of the second rollers 341, rubber pads may be sleeved on the second rollers 341, or the contact surfaces 3411 may be provided with ribs and grooves. The paper feeding unit 34 may further include other rollers (not shown) so that the paper of the roll of paper 4 may roll over the other rollers prior to entering the dispensing hole 333 to position the paper more effectively. In this embodiment, the second rollers 341 have the same diameter. However, in other embodiments, they may have different diameters.

The paper feeding unit 34 further includes a paper guide unit 342 mounted pivotally inside the base casing 33 proximate to the second rollers 341. The paper guide unit 342 is movable toward and away from the second rollers 341, and includes a guide bar 3421 substantially parallel to the partition walls 3311, and two guide arms 3422 that extend outwardly, curvedly and respectively from two opposite ends of the guide bar 3421 and that are connected pivotally to the lateral sections of the surrounding wall 332 of the base casing 33. The guide bar 3421 can be moved toward the second rollers 341 so as to push the paper to a position between the second rollers 341.

The drive unit 35 is mounted on the surrounding wall 332 of the base casing 33, and is connected to the paper feeding unit 34. The drive unit 35 includes a motor 351, a driving gear 352 connected to the motor 351, and a driven gear 353 meshed with the driving gear 352 and connected to one of the second rollers 341.

The paper cutter 36 is mounted on one of the partition walls 3311 of the base casing 33. The paper cutter 36 includes a blade portion 361 extending into the dispensing hole 333 and having a serrated edge to facilitate cutting of the paper of the roll of paper 4.

The sensor unit 37 is disposed within the main housing 31, and includes a contact type sensor. The contact type sensor includes a contact member 371 having one end 3711 extending into the dispensing hole 333 and the other end 3712 connected electrically to the drive unit 35 through a control unit 39 mounted within the base casing 33. One of the partition walls 3311 that is distal from the rear section of the surrounding wall 332 is formed with a notch 3312. The contact member 371 is inserted into the notch 3312, and the one end 3711 of the contact member 371 is disposed proximate to the blade portion 361.

When a section of the paper of the roll of paper 4 is pressed against the blade portion 361 to effect cutting, the blade portion 361 contacts the one end 3711 of the contact member 371, and a signal is sent to the control unit 39. The control unit 39 activates the drive unit 35 to drive the second rollers 341 to rotate. When the second rollers 341 rotate, another section of the paper is advanced into the dispensing hole 333. In this embodiment, the mechanism to feed the paper of the roll of paper 4 is the contact type sensor, but should not be limited to this particular type of sensor.

The sensor unit 37 further includes a light sensor 373 (see FIG. 3) mounted within the base casing 33 and connected electrically to the drive unit 35 through the control unit 39. The light sensor 373 projects light through a sensor opening 311c in the front wall 3111 of the front casing 311. When a user's body or hand is sensed by the light sensor 373, a signal is transmitted to the control unit 39 so that the drive unit 35 drives the second rollers 341, thereby advancing another section of the paper into the dispensing hole 333.

The control unit 39 includes a control switch (not shown) to energize the drive unit 35 upon receiving a signal from the contact type sensor 372 or the light sensor 373, and an adjustment switch (not shown) to adjust the length of the paper that is fed into the dispensing hole 333.

To power the drive unit 35 and the sensor unit 37, a power supply unit 38 is provided in the main housing 31, and is connected electrically to the drive unit 35 and the sensor unit 37. In this embodiment, the power supply unit 38 includes a battery seat 381 disposed in the base casing 33, and a plurality of batteries (not shown) mounted on the battery seat 381 for supplying electricity. The power supply unit 38 may also include a power plug used for connection to a wall socket to supply the required drive power.

The front casing 311 may be detached from the rear casing 312 and the base casing 33 by inserting a key 74 into the hole at the top end 311b of the front casing 311 in order to load the batteries on the battery seat 381 and to mount the roll of paper 4 on the first roller 32. After mounting the roll of paper 4, the paper of the roll of paper 4 is pulled downwardly, and the guide bar 3421 is pushed rearwardly so that the paper is moved to a position between the second rollers 341. The front and rear casings 311, 312 are then closed. When the light sensor 373 produces a signal, the drive unit 35 rotates the second rollers 341, which in turn advance a section of the paper of the roll of paper 4 into the dispensing hole 333.

When the paper is pressed against the blade portion 361 of the paper cutter 36, the contact member 371 is moved so that a signal is sent to the drive unit 35, thereby effecting operation of the second rollers 341 to feed the paper into the dispensing hole 333.

From the aforementioned description of the preferred embodiment, it is apparent that through the sensor unit 37, the paper can be fed automatically into the dispensing hole 333 for use such that the rolled paper dispenser 300 of the present invention is not only convenient to use, but also can enhance the sanitation after washing of the hands. Further, since the rolled paper dispenser 300 of the present invention has a simple structure and is easy to assemble, production costs and the assembly time may be minimized. Finally, the length of the paper dispensed from the dispensing hole 333 may be controlled, and unnecessary waste of paper is prevented.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

I claim:

1. A rolled paper dispenser comprising:
a main housing having a dispensing hole;
a first roller mounted removably within said main housing and adapted to support a roll of paper;
a paper feeding unit including a pair of contacting second rollers mounted rotatably within said main housing for advancing the paper from the roll of paper;
a drive unit disposed within said main housing and connected to said paper feeding unit;
a paper cutter disposed within said main housing adjacent to said dispensing hole; and
a sensor unit disposed within said main housing and connected electrically to said drive unit to activate said second rollers through said drive unit so as to control advancement of a section of the paper to said dispensing hole.

2. The rolled paper dispenser as claimed in claim 1, wherein said main housing includes a rear casing having a bottom end and a top end, a base casing inserted partially into and attached to said rear casing adjacent to said bottom end of said rear casing, and a front casing having a bottom end connected pivotally to said base casing and a top end connected detachably to said top end of said rear casing, said base casing being formed with said dispensing hole.

3. The rolled paper dispenser as claimed in claim 2, wherein said base casing is attached removably to said rear casing.

4. The rolled paper dispenser as claimed in claim 2, wherein said second rollers are mounted rotatably within said base casing, said paper cutter being disposed inside said base casing and including a blade portion extending into said dispensing hole.

5. The rolled paper dispenser as claimed in claim 4, wherein said sensor unit includes a contact member disposed proximate to said blade portion to contact said blade portion when a section of the paper is pressed against said blade portion to effect cutting so that a signal is sent to said drive unit.

6. The rolled paper dispenser as claimed in claim 1, wherein said drive unit includes a motor, a driving gear connected to said motor, and a driven gear meshing with said driving gear and connected to one of said second rollers.

7. The rolled paper dispenser as claimed in claim 1, wherein said sensor unit includes a light sensor provided in said main housing and connected electrically to said drive unit.

8. The rolled paper dispenser as claimed in claim 2, wherein said main housing further includes two spaced apart support arms connected to said rear casing for supporting said first roller.

9. The rolled paper dispenser as claimed in claim 8, further comprising a fastening unit, said fastening unit including a projection that projects downwardly from said top end of said front casing, and a resilient hook provided on said top end of said rear casing to engage resiliently said projection.

10. The rolled paper dispenser as claimed in claim 2, wherein said front casing includes a front wall formed with an opening, and a transparent plate to cover said opening.

11. The rolled paper dispenser as claimed in claim 2, wherein said paper feeding unit further includes a paper guide unit mounted pivotally inside said base casing proximate to said second rollers, said paper guide unit being movable toward and away from said second rollers.
